(19) United States
(12) Patent Application Publication
(10) Pub. No.: US 2009/0247338 A1
(43) Pub. Date: Oct. 1, 2009

(54) Pulley wheel

(76) Inventor: Fu-Di Hwang, Yang-Mei Town (TW)

Correspondence Address: TROXELL LAW OFFICE PLLC, 5205 LEESBURG PIKE, SUIE 1404, FALLS CHURCH, VA, 22041, US

(21) Appl. No.: 12/078,512

(22) Filed: Apr. 1, 2008

(51) Int. Cl. F16H 55/00

(52) U.S. Cl. 474/166

(57) ABSTRACT

A pulley wheel adapted to a roll seat of a door or a window includes a hollow wheel seat and a bush; the wheel seat being comprised of a first and a second ring seat and defining a ring space between both ring seats; two concentric slotted holes being respectively disposed at axes of both ring seats to make a set of connection hole for receiving tight placement of the bush therein; and both ring seats being each med of a metal plate punched into shape with a hollow space to provide easy production of the pulley wheel and reduced production costs.

### BACKGROUND OF THE INVENTION

(a) Field of the Invention

The present invention is related to a pulley wheel, and particularly to one that is applied to a roll seat mounted to a door/window.

(b) Description of the Prior Art:

Referring to FIG. 1 of the accompanying drawings of the present invention for a sectional view of a pulley wheel of the prior art adapted to a door/window, a pulley wheel 10 is mounted to a trench 21 provided in a bottom rail of a door/window and slides on a track 30. The conventional pulley wheel 10 includes a wheel seat 11, a pulley 12, and a bearing 13, wherein the bearing 13 is mounted to where an axis of the pulley 12 is located before placing the pulley 12 in the wheel seat 11, and is then disposed in the trench 21 by means of the wheel seat 11. However, the pulley 12 in the wheel seat 11 is lathe machined using a solid copper bar; and a lot of waste of material will be consumed in the process to machine the solid copper bar into a profile as desired and to drill a central hole. The conventional process of manufacturing a puller 12 not only costs more due to that the solid copper bar is used; involves complicated production, and produces excessively waste of material consumed.

### SUMMARY OF THE INVENTION

The primary purpose of the present invention is to provide a hollow pulley wheel to solve the problem of higher production cost and complicated process found with the prior art.

To achieve the purpose, a pulley wheel of the preset invention is comprised of a hollow wheel seat and a bush. Wherein the hollow wheel seat is comprised of a first ring base and a second ring base incorporated to each other; a ring space is defined between both ring seats; a first slotted hole and a second slotted hole are concentrically provided at the axes respectively of the first and the second ring seats to form a set of assembly holes while the bush is secured into the assembly holes. Where as the hollow wheel seat is comprised of the first and the second ring seats with both ring seats made of metallic plate to be punched into shape, and the hollow wheel seat contains a hollow structure to permit easy process and minimized consumption of material.

### BRIEF DESCRIPTION OF THE DRAWINGS

FIG. 1 is a sectional view of a pulley wheel of the prior art adapted to a door or a window.

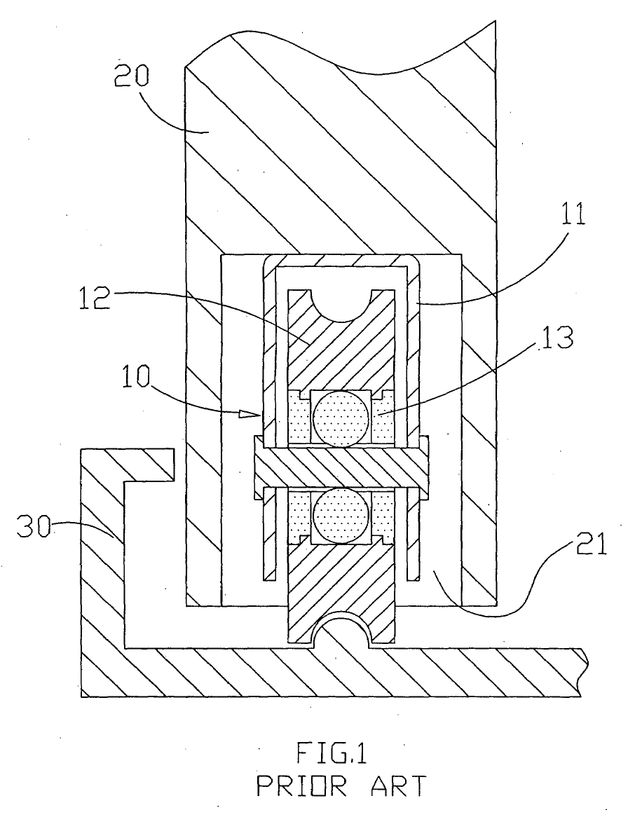

FIG. 2 is a perspective view of a preferred embodiment of the present invention.

FIG. 3 is an exploded view of the preferred embodiment of the present invention.

FIG. 4 is a sectional view of the preferred embodiment of the preset invention.

FIG. 5 is a schematic view showing a cross-section of a second ring seat of the preferred embodiment of the present invention.

### DETAILED DESCRIPTION OF THE PREFERRED EMBODIMENTS

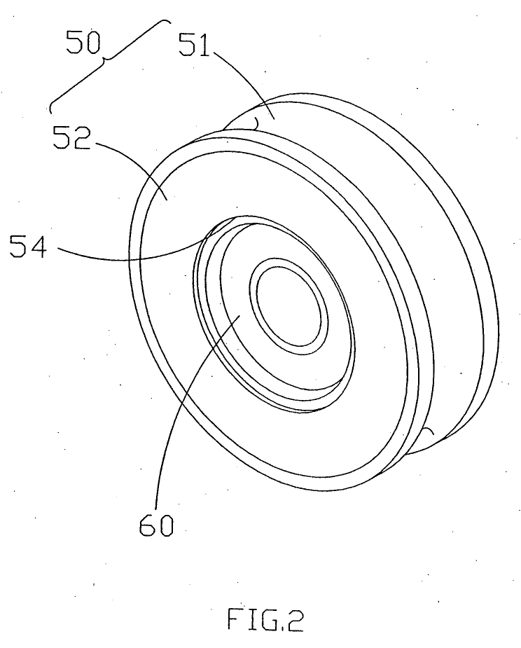

Referring to FIGS. 2, 3, and 4, a preferred embodiment of a pulley wheel of the present invention is essentially adapted to a roll seat of a door or a window and is comprised of a hollow wheel seat 50 and a bush 60. Wherein, the hollow wheel seat 50 has a first ring seat 51 and a second ring seat 52 incorporated to each other; each of both of the first and the second ring seats 51, 52 is made of a metal plate punched into shape; a ring space 53 is defined between both ring seats 51 and 52; and a first slotted hole 511 and a second slotted hole 521 are concentrically disposed at two axes respectively of the first ring seat 51 and the second ring seat 52. Accordingly, when the second ring seat 52 is incorporated with the first ring seat 51, both of the first slotted hole 511 and the second slotted hole 521 are combined to each other to form a set of connection hole 54 for the bush 60 to be tightly disposed in the connection hole 54 to complete an assembly of a pulley wheel 50 of the present invention. Alternatively, the bush 60 maybe related to a bearing. Whereas the preferred embodiment comprised of the first and the second ring seats 51 and 52 is related to a hollow structure with each of both seats made of metal plate punched into shape and the ring space 53 being defined between both ring seats to allow easy process and minimum consumption of material to achieve the purpose of production and process costs.

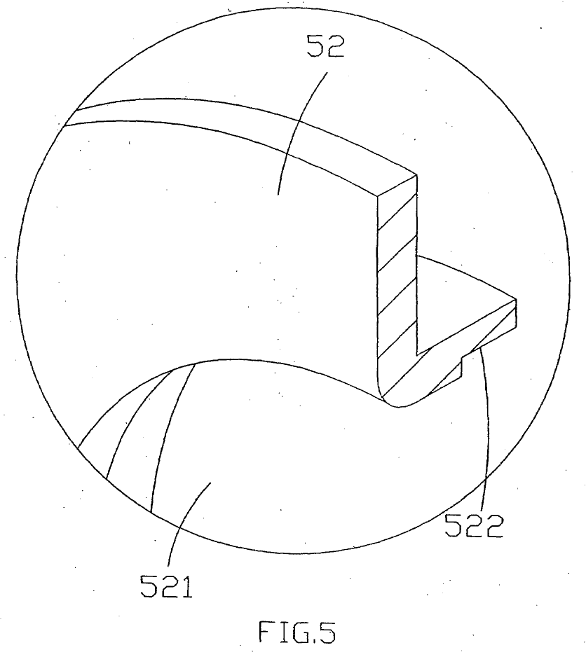

Now referring to FIG. 5, tow gradations 512 and 522 are respectively molded at where both of the first slotted hole 511 and the second slotted hole 521 correspond to the connection hole 54 to clamp the bush 60 right in the middle at where between the first ring seat 51 and the second ring seat 52 for preventing the bush 60 from falling off position when subject to external force applied.

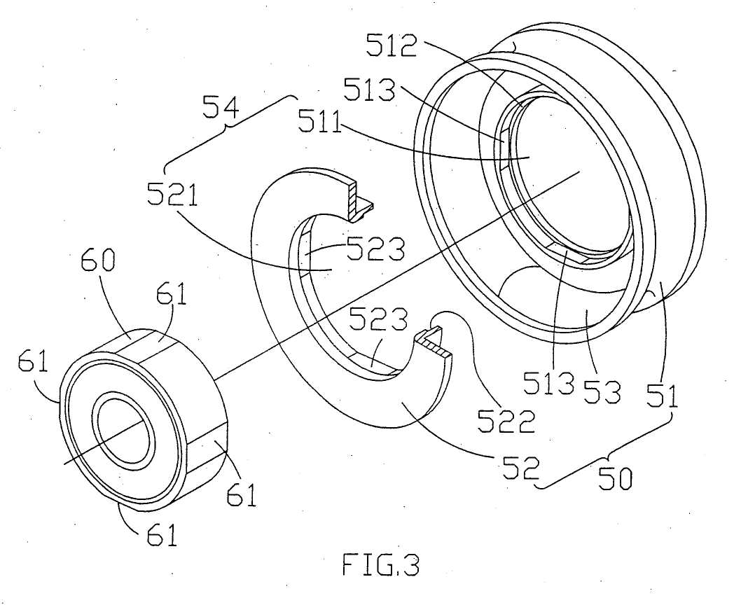

As illustrated in FIG. 3, one or a plurality of resistance portion 61 is disposed to an outer circumference of the bush 60. In the preferred embodiment, four resistance portions 61 are provided and spaced at equal interval; and each resistance portion 61 is related to a straight and flushed section, a recessed arc plane, or an arc plane of non-regular circle. That is, the profile of the bush 60 is not related to a regular circle and when mounted in the first slotted hole 511 and/or the second slotted hole 521, a side wall of the first slotted hole 511 and/or a side wall of the second slotted hole 521 compress against those resistance portions 61 so to secure the bush 60 in the first slotted hole 511 and/or the second slotted hole 521; or alternatively, either or both of the side wall of the first slotted hole 511 and the second slotted hole 521 is disposed with one or a plurality of holding portion 513, 523 to hold against a corresponding resistance portion 61 of the bush 60 to prevent the bush 60 from idling.

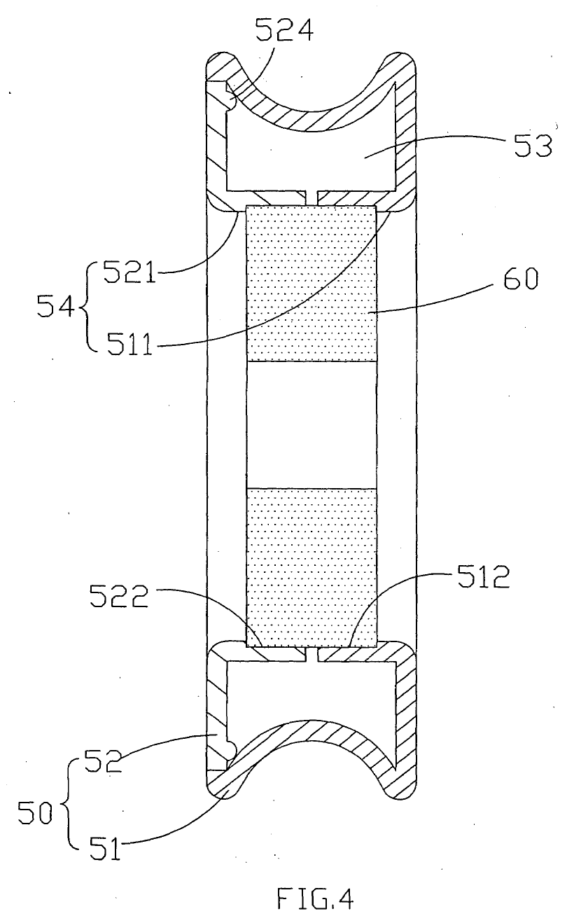

To fortify connection between the first and the second ring seats 51 and 52, both of the first and the second ring seats 51 and 52 are connected to each other by spot welding as illustrated in FIG. 4. Therefore, a flange 524 is disposed on an inner side of the second ring seat 52 to contact and press an outer circumference of the second ring seat 52 for improving the connection between the first and the second ring seats 51 and 52.

The flange 524 disposed on the inner side of the second ring seat 52 may be replaced with multiple nipples (an approach generally known to those who are familiar with the art, therefore not illustrated). Those nipples are disposed at where close to the outer circumference of the second ring seat 52 and the same spot welding method is used to reinforce the connection between the first and the second ring seats 51 and 52.

The present invention by disclosing a design concept of a hollow pulley wheel to simplify the manufacturing process and reduce costs for the production of the pulley wheel meets requirements of an innovative patent; therefore this application for a patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim,

1. A pulley wheel adapted to a roll seat of a door or a window, comprising:
a hollow wheel seat having a first ring seat and a second ring seat incorporated to the first ring seat; a first slotted hole and a second slotted hole being concentrically and respectively formed at their axes; both of the first and the second slotted holes forming a set of connection hole; and
a bush tightly placed in the set of connection hole.

2. The pulley wheel as claimed in claim 1, wherein two gradations are respectively disposed to where both of the first and the second slotted holes corresponding to the connection hole.

3. The pulley wheel as claimed in claim 1, wherein one or a plurality of resistance portion is disposed to the bush.

4. The pulley wheel as claimed in claim 3, wherein each resistance portion is related to a straight and flushed section, a recessed arc plane, or an arc plane of non-regular circle.

5. The pulley wheel as claimed in claim 3, wherein those resistance portions disposed on inner walls respectively of the first and the second slotted holes are compressed by the bush installed in the first and the second slotted holes; and the bush is secured in the first and the second slotted holes.

6. The pulley wheel as claimed in claim 3, wherein the resistance portion disposed on the wall of the first or the second slotted hole is compressed by the bush when the bush is installed in the first or the second slotted hole; and the bush is secured in the first or the second slotted hole.

7. The pulley wheel as claimed in claim 3, wherein each of both of the first and the second slotted hole has on its wall disposed with one or a plurality of holding portions to hold against its corresponding resistance portion of the bush.

8. The pulley wheel as claimed in claim 3, wherein the side wall of the first or the second slotted hole is disposed with a or a plurality of holding portion to hold against its corresponding resistance portion.

9. The pulley wheel as claimed in claim 1, wherein a flange is formed on an inner side of the second ring seat; the flange is located at where close to an outer circumference of the second ring seat; and the flange is connected to the outer circumference of the second ring seat by spot welding to reinforce fixation of the first and the second ring seats.

10. The pulley wheel as claimed in claim 1, wherein multiple nipples are formed on the inner side of the second ring seat; those nipples are located at where close to an outer circumference of the second ring seat; and those nipples are connected to the outer circumference of the second ring seat by spot welding to reinforce fixation of the first and the second ring seats.

11. The pulley wheel as claimed in claim 1, wherein a ring space is defined between the first and the second ring seats.

12. The pulley wheel as claimed in claim 1, wherein the first ring seat is made of a metal plate punched into shape.

13. The pulley wheel as claimed in claim 1, wherein the second ring seat is made of a metal plate punched into shape.

14. The pulley wheel as claimed in claim 1, wherein the bush is related to a bearing.
